(19) United States
(12) Patent Application Publication
(10) Pub. No.: US 2022/0404726 A1
(43) Pub. Date: Dec. 22, 2022

(54) TONER

(71) Applicant: KYOCERA Document Solutions Inc., Osaka (JP)

(72) Inventor: Haruhiro HATAJIRI, Osaka-shi (JP)

(73) Assignee: KYOCERA Document Solutions Inc., Osaka (JP)

(21) Appl. No.: 17/807,322

(22) Filed: Jun. 16, 2022

(30) Foreign Application Priority Data
Jun. 18, 2021 (JP) 2021-101497

(51) Int. Cl. G03G 9/08; G03G 9/087; G03G 9/097

(52) U.S. Cl. CPC G03G 9/0819; G03G 9/0815; G03G 9/0817; G03G 9/081; G03G 9/08755; G03G 9/09725; G03G 9/09716

(57) ABSTRACT

A toner includes toner particles. The toner particles each include a toner mother particle and an external additive attached to the surface of the toner mother particle. The external additive contains specific external additive particles and silica particles. The specific external additive particles each include a base containing barium titanate and a coat layer covering the base. The coat layer contains antimony tin oxide. Mass ratios of metal elements contained in the toner particles satisfy 0.10<(Ba/Si)<0.60 (formula (1)); 0.05<(Ba/Si)<0.20 (formula (2)); and 1.5<(Sn/Ba)<5.0 (formula (3)).

### INCORPORATION BY REFERENCE

The present application claims priority under 35 U.S.C. § 119 to Japanese Patent Application No. 2021-101497, filed on Jun. 18, 2021. The contents of this application are incorporated herein by reference in their entirety.

### BACKGROUND

The present disclosure relates to a toner.

In electrophotographic image formation, a toner including toner particles is used. The toner particles include for example toner mother particles and an external additive attached to the surfaces of the toner mother particles. An example of the external additive is titanium oxide particles. The titanium oxide particles perform a function to abrade the surface of an electrophotographic photosensitive member and a function to stabilize the amount of charge of the toner particles. The toner including the titanium oxide particles with the above functions can inhibit occurrence of fogging (specifically, a phenomenon in which toner is attached to a non-printed portion) and image flow (specifically, a phenomenon in which an image flows as if rubbed to be blurred).

The titanium oxide particles was previously classified as “Group 3 (not classifiable (uncertain) as to its carcinogenicity to humans) but is now classified as “Group 2B (possibly carcinogenic to humans) in a list of information indicating carcinogenic risk information drafted by International Agency for Research on Cancer (IARC). In this connection, use of the titanium oxide particles is becoming increasingly restricted particularly in Europe. In Europe, for example, it is required to indicate a warning notation for a toner including toner particles including at least 1% by mass of titanium oxide particles. Under the circumstances as above, alternatives to the titanium oxide particles are being studied in the field of toners. Examples of the alternatives of the titanium oxide particles include strontium titanate particles. A toner containing perovskite titanium oxide compound as a main component and including strontium titanate-based fine particles containing the third component selected from La, Mg, Ca, Sn, and Si is proposed as a toner containing strontium titanate particles.

### SUMMARY

A toner according to an aspect of the present disclosure includes toner particles. The toner particles each include a toner mother particle and an external additive attached to a surface of the toner mother particle. The external additive contains specific external additive particles and silica particles. The specific external additive particles each include a base containing barium titanate and a coat layer covering the base. The coat layer contains antimony tin oxide. Mass ratios of metal elements contained in the toner particles satisfy formulas (1) to (3) below.

0.10<(Ba/Ti)<0.60 (1)

0.05<(Ba/Si)<0.20 (2)

1.5<(Sn/Ba)<5.0 (3)

### BRIEF DESCRIPTION OF THE DRAWINGS

FIG. 1 is a schematic cross section of an example of a toner particle included in a toner according to the present disclosure.

FIG. 2 is a schematically cross section of an example of a specific external additive particle.

FIG. 3 is a schematically cross section of another example of the specific external additive particle which is different from that in FIG. 2.

### DETAILED DESCRIPTION

The following describes a preferable embodiment of the present disclosure. Note that a toner is a collection (e.g., a powder) of toner particles. An external additive is a collection (e.g., a powder) of external additive particles. Unless otherwise stated, an evaluation result (e.g., a value indicating a shape or a physical property) for a powder (specific examples include a powder of toner particles or a powder of external additive particles) is a number average of values measured for a suitable number of the particles.

Values for volume median diameter (D₅₀) of a powder are values as measured based on the Coulter principle (electrical sensing zone technique) using a particle size distribution analyzer (e.g., “COULTER COUNTER MULTISIZER 3”, product of Beckman Coulter, Inc.) unless otherwise stated.

Unless otherwise stated, the number average particle diameter of a powder is a number average of equivalent circle diameters (Heywood diameter: diameters of circles having the same areas as projected areas of the primary particles) of primary particles of the powder as measured using a scanning electron microscope. The number average primary particle diameter of a powder is a number average of equivalent circle diameters of 100 primary particles of the powder, for example. Note that the number average primary particle diameter of particles refers to a number average primary particle diameter of the particles of a powder unless otherwise stated.

Chargeability refers to chargeability in triboelectric charging unless otherwise stated. For example, a measurement target (e.g., a toner) is triboelectrically charged by mixing and stirring the measurement target together with a standard carrier (standard carrier for negatively chargeable toner: N-01, standard carrier for positively chargeable toner: P-01) provided by The Imaging Society of Japan. The amount of charge of the measurement target is measured before and after triboelectric charging using for example a compact toner draw-off charge measurement system (“MODEL 212HS”, product of TREK, INC.). A larger change in amount of charge between before and after triboelectric charging indicates higher chargeability of the measurement target.

The term “main component” of a material refers to a component the most abundant component in the material in terms of mass. In the present specification, barium (Ba), titanium (Ti), silicon (Si), and tin (Sn) may be indicated by their element symbols.

Values for softening point (Tm) are values as measured using a capillary rheometer (e.g., “CFT-500D”, product of Shimadzu Corporation) unless otherwise stated. On an S-shaped curve (vertical axis: temperature, horizontal axis: stroke) measured using the capillary rheometer, the softening point (Tm) corresponds to a temperature corresponding to a stroke value of “(base line stroke value+maximum stroke value)/2”. Values for glass transition point (Tg) are values as measured in accordance with “the Japanese Industrial Standard (JIS) K7121-2012” using a differential scanning calorimeter (e.g., “DSC-6220”, product of Seiko Instruments Inc.) unless otherwise stated. The glass transition point corresponds to the temperature corresponding to a point of inflection (specifically, an intersection point of an extrapolated baseline and an extrapolated falling line) caused by glass transition on a heat absorption curve (vertical axis: heat flow (DSC signal), horizontal axis: temperature) plotted using the differential scanning calorimeter.

In the following description, the term “-based” may be appended to the name of a chemical compound to form a generic name encompassing both the chemical compound itself and derivatives thereof. When the term “-based” is appended to the name of a chemical compound used in the name of a polymer, the term indicates that a repeating unit of the polymer originates from the chemical compound or a derivative thereof. The term “(meth)acryl” is used as a generic term for both acryl and methacryl.

### Toner

A toner according to the present disclosure includes toner particles. The toner particles each include a toner mother particle and an external additive attached to the surface of the toner mother particle. The external additive contains specific external additive particles and silica particles. The specific external additive particles each include a base containing barium titanate and a coat layer covering the base. The coat layer contains antimony tin oxide. The mass ratios of metal elements contained in the toner particles satisfy formulas (1) to (3) below.

0.10<(Ba/Si)<0.60 (1)

0.05<(Ba/Si)<0.20 (2)

1.5<(Sn/Ba)<5.0 (3)

The toner of the present disclosure is suitable for use as a positively chargeable toner for developing electrostatic latent images, for example. The toner of the present disclosure may be used as a one-component developer. The toner of the present disclosure may be mixed with a carrier using a mixer (e.g., a ball mill) for use as a two-component developer. When used as a one-component developer, the toner of the present disclosure is for example positively charged by friction with a development sleeve or a toner charging member in a development device. The toner charging member is a doctor blade, for example. When constituting a two-component developer, the toner of the present disclosure is for example positively charged by friction with a carrier in the development device. The toner will be described in detail below with reference to the drawings as appropriate.

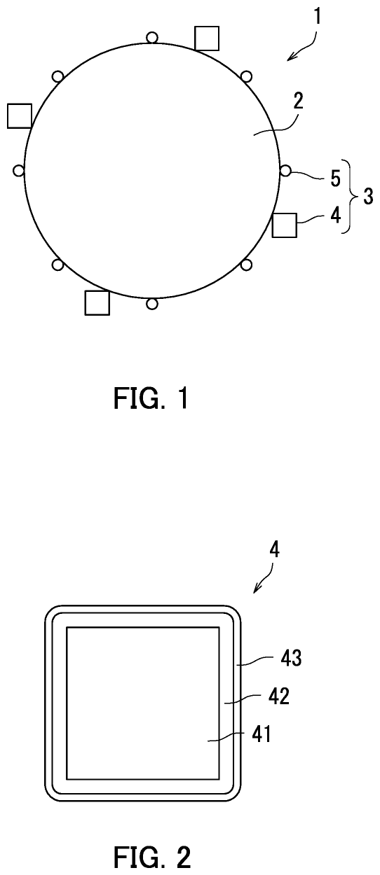

FIG. 1 illustrates an example of a toner particle 1 included in the toner. The toner particle 1 illustrated in FIG. 1 includes a toner mother particle 2 and an external additive 3 attached to the surface of the toner mother particle 2. The external additive 3 contains specific external additive particles 4 and silica particles 5. The specific external additive particles 4 are substantially cubic in shape.

FIG. 2 illustrates one example of a specific external additive particle 4. The specific external additive particle 4 illustrated in FIG. 2 includes a base 41, a coat layer 42 covering the base 41, a surface treated layer 43 covering the coat layer 42. The base 41 contains barium titanate. The coat layer 42 contains antimony tin oxide. The surface treated layer 43 contains a component derived from a surface treatment agent. Preferably, the surface treated layer 43 contains a component derived from a silane coupling agent.

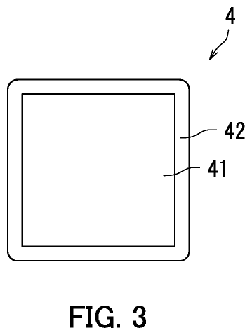

FIG. 3 illustrates another example of the specific external additive particle 4 which is different from that in FIG. 2. The specific external additive particle 4 illustrated in FIG. 3 includes a base 41 and a coat layer 42 covering the base 41. The base 41 contains barium titanate. The coat layer 42 contains antimony tin oxide. The specific external additive particle 4 illustrated in FIG. 3 differs from the specific external additive particle 4 illustrated in FIG. 2 in not including the surface treated layer 43.

The toner particles have been described with reference to the drawings. However, the toner particles may have structure different from that of the toner particle 1 illustrated in FIG. 1. Specifically, the toner particles may include particles (also referred to below as “additional external additive particles”) other than the specific external additive particles and the silica particles as an external additive. The toner mother particles may be capsule toner particles each including a toner core and a shell layer covering the toner core. The specific external additive particles may have a shape (e.g., a substantially spherical shape) other than the substantially cubic shape. The specific external additive particles may each further include a layer other than the coat layer and the surface treated layer.

As a result of having the above features, the toner of the present disclosure can inhibit occurrence of fogging and image flow. The reasons thereof will be described below. Toner particles typically contain silica particles as an external additive for the purpose of increasing charge retention and fluidity. By contrast, the silica particles have a high volume resistivity and exhibit a property of readily holding electric charge. Therefore, when the toner particles containing the silica particles are subjected to stress of long-term retention in a development device, local charge concentration may occur to invite fogging. Local charge concentration in the toner particles can be inhibited by use of external additive particles with a high dielectric constant and a low volume resistivity in combination.

The toner particles of the toner in the present disclosure includes the specific external additive particles as an external additive. The specific external additive particles include bases containing barium titanate that is a compound with an extremely high dielectric constant. Furthermore, the specific external additive particles include coat layers containing antimony tin oxide (ATO) that is a compound excellent in conductivity. As such, the specific external additive particles include the bases containing barium titanate and the coat layers containing ATO to have a high dielectric constant and a low volume resistivity. As a result of including the specific external additive particles such as above, the toner of the present disclosure can inhibit local charge concentration in the toner particles.

In electrophotography, dirt adheres to the surface of a photosensitive member through printing to cause image flow. However, barium titanate has a high Mohs hardness and has an angular shape (substantially cubic shape) derived from the perovskite crystal structure. The specific external additive particles, which include the bases containing barium titanate, have a function as abrasive particles. As a result of containing the specific external additive particles such as above, the toner of the present disclosure can clean dirt adhered to the surface of the photosensitive member.

Furthermore, the mass ratios of the metal elements contained in the toner particles of the toner of the present disclosure satisfy the aforementioned formulas (1) to (3). Here, in formulas (1) to (3), Ba and Ti are mainly derived from barium titanate contained in the bases of the specific external additive particles. Si is mainly derived from silicon dioxide contained in the silica particles. Sn is mainly derived from antimony tin oxide contained in the coat layers of the specific external additive particles. Where the toner particles contain the specific external additive particles including the bases containing barium titanate, the toner particles satisfy formula (1) for the mass ratio (Ba/Ti). Where the content ratio between the specific external additive particles and the silica particles is appropriate in the toner particles, the toner particles satisfy formula (2) for the mass ratio (Ba/Si). Where the specific external additive particles include the coat layers with a mass appropriate to the mass of the bases, the toner particles satisfy formula (3) for the mass ratio (Sn/Ba). As such, as a result of the aforementioned formulas (1) to (3) being satisfied, image flow and fogging can be inhibited and it can be ensured that the specific external additive particles exhibit the aforementioned function in the toner of the present disclosure.

Note that a known toner uses titanium oxide particles as an external additive in order to inhibit occurrence of fogging and image flow. However, the use of the titanium oxide particles is becoming increasingly restricted particularly in Europe as described above. The toner of the present disclosure can inhibit occurrence of fogging and image flow even if no titanium oxide particles are used. Therefore, it is preferable that the toner particles of the toner of the present disclosure does not substantially contain titanium oxide. The content ratio of titanium oxide in the toner particles is preferably less than 1.0% by mass, more preferably no greater than 0.1% by mass, and further preferably 0.0% by mass.

The toner of the present disclosure will be described further in detail below. Note that one type of each component described below may be used independently or two or more types of the component may be used in combination.

### Mass Ratios of Metal Elements

The mass ratios of the metal elements contained in the toner particles can be measured by fluorescent X-ray analysis. Specific examples of a measurement method thereof include a method described in Examples and methods conforming thereto.

### (Ba/Ti)

The mass ratio Ba/Ti is greater than 0.10 and less than 0.60, preferably greater than 0.25 and less than 0.45, and more preferably greater than 0.35 and less than 0.40. Where the mass ratio Ba/Ti is no greater than 0.10 or at least 0.60, the toner particles do not include the specific external additive particles or contain a large amount of other titanium-containing particles (specific examples include strontium titanate particles and titanium oxide particles). In such a case, it is difficult for the specific external additive particles to exhibit the aforementioned function. As a result of having a mass ratio Ba/Ti of greater than 0.10 and less than 0.60, the toner of the present disclosure can inhibit fogging and image flow.

### (Ba/Si)

The mass ratio Ba/Si is greater than 0.05 and less than 0.20, and preferably greater than 0.10 and less than 0.15. The content ratio between the specific external additive particles and the silica particles in the toner particles is important because the specific external additive particles and the silica particles perform different roles. Where the mass ratio Ba/Si is greater than 0.05 and less than 0.20, the specific external additive particles in an appropriate amount relative to the amount of the silica particles are contained in the toner particles. As a result, the toner of the present disclosure can inhibit occurrence of image flow.

### (Sn/Ba)

The ratio Sn/Ba is greater than 1.5 and less than 5.0, preferably greater than 2.0 and less than 4.5, and more preferably greater than 2.5 and less than 4.0. The mass ratio Sn/Ba corresponds to a ratio of the mass of the coat layers to the mass of the bases of the specific external additive particles. The higher the ratio Sn/Ba is, the lower the volume resistivity of the specific external additive particles is. As a result of the ratio Sn/Ba being set to greater than 1.5 and less than 5.0, the toner of the present disclosure can inhibit occurrence of image flow. However, the silica particles may be subjected to surface treatment with antimony tin oxide. Therefore, the mass ratio Sn/Ba may not exactly correspond to the mass ratio between the bases and the coat layers.

### External Additive

The external additive is attached to the surfaces of the toner mother particles. The external additive contains the specific external additive particles and the silica particles.

### Specific External Additive Particles

The specific external additive particles each include a base containing barium titanate and a coat layer covering the base. The coat layers contain antimony tin oxide. Preferably, the specific external additive particles each further include a surface treated layer covering the coat layer. Preferably, the surface treated layers contain a component derived from a silane coupling agent.

The specific external additive particles have a number average primary particle diameter of preferably at least 20 nm and no greater than 300 nm, and more preferably at least 60 nm and no greater than 130 nm. As a result of the number average primary particle diameter of the specific external additive particles being set to at least 20 nm, the specific external additive particles can be inhibited from being buried in the toner mother particles. As a result of the number average primary particle diameter of the specific external additive particles being set to no greater than 300 nm by contrast, the specific external additive particles can be inhibited from being detached from the toner mother particles.

Preferably, the number average primary particle diameter of the specific external additive particles is larger than the number average primary particle diameter of the silica particles. As a result of the number average primary particle diameter of the specific external additive particles being larger than the number average primary particle diameter of the silica particles as above, the specific external additive particles can readily exhibit abrasive action. Accordingly, the toner of the present disclosure can further effectively inhibit occurrence of image flow.

The content ratio of the specific external additive particles in the toner particles is preferably at least 0.3 parts by mass and no greater than 5.0 parts by mass relative to 100 parts by mass of the toner mother particles, more preferably at least 0.5 parts by mass and no greater than 3.0 parts by mass, and further preferably at least 1.4 parts by mass and no greater than 2.0 parts by mass. As a result of the content ratio of the specific external additive particles being set to at least 0.3 parts by mass and no greater than 5.0 parts by mass, the toner of the present disclosure can further effectively inhibit occurrence of fogging and image flow.

### Bases

The bases contain barium titanate. The percentage content of the barium titanate in the bases is preferably at least 80% by mass, more preferably at least 97% by mass, and further preferably 100% by mass.

Preferably, the bases are particles with substantially angular, cubic particles. However, the bases may have another shape (e.g., a spherical shape). The number average primary particle diameter of the bases is roughly the same as the number average primary particle diameter of the specific external additive particles.

### Coat Layers

The coat layers contain antimony tin oxide. The percentage content of antimony tin oxide in the coat layers is preferably at least 80% by mass, more preferably at least 97% by mass, and further preferably 100% by mass.

A ratio (amount of substance of antimony atoms/(amount of substance of tin atoms+amount of substance of antimony atoms)) of the amount of substance of antimony atoms to the total amount of substance of tin atoms and the antimony atoms in the coat layers is preferably at least 0.09 and no greater than 0.29, and more preferably at least 0.15 and no greater than 0.25. As a result of the above ratio being set to at least 0.09 and no greater than 0.29, the volume resistivity of the specific external additive particles can be further reduced. Accordingly, the toner of the present disclosure can further effectively inhibit occurrence of fogging.

### Surface Treated Layers

The surface treated layers are layers formed by surface treatment with a surface treatment agent. The surface treated layers contain a component derived from the surface treatment agent. The surface treatment agent is preferably a silane coupling agent. That is, the surface treated layers preferably contain a component derived from a silane coupling agent.

The silane coupling agent is preferably alkylalkoxysilane (particularly, monoalkytrialkoxysilane), and more preferably isobutyltrimethoxysilane. An alkyl group of alkylalkoxysilane is preferably an alkyl group with a carbon number of at least 3 and no greater than 8.

Examples of alkylalkoxysilane include propyltrimethoxysilanes (specific examples include n-propyltrimethoxysilane and isopropyltrimethoxysilane), propyltriethoxysilanes (specific examples include n-propyltriethoxysilane and isopropyltriethoxysilane), butyltrimethoxysilanes (specific examples include n-butyltrimethoxysilane and isobutyltrimethoxysilane), butyltriethoxysilanes (specific examples include n-butyltriethoxysilane and isobutyltriethoxysilane), hexyltrimethoxysilanes (specific examples include n-hexyltrimethoxysilane), hexyltriethoxysilanes (specific examples include n-hexyltriethoxysilane), octyltrimethoxysilanes (specific examples include n-octyltrimethoxysilane), and octyltriethoxysilanes (specific examples include n-octyltriethoxysilane).

### Method for Preparing Specific External Additive Particles

A method for preparing the specific external additive particles is for example a preparation method including a base preparation process of preparing the bases and a coat layer formation process of covering the bases with the coat layers. Preferably, the method for preparing the specific external additive particle further includes a surface treatment process of performing surface treatment on the coat layers.

### Base Preparation Process

No particular limitations are placed on a base preparation method, and examples of the method include a method (baking) for mixing a titanium compound (e.g., titanium oxide or metatitanic acid) and a barium compound (e.g., barium carbonate) and baking the resultant mixture.

Alternatively, an atmospheric pressure heating reaction method may be employed as the base preparation method. Bases with a smaller number average primary particle diameter tend to be obtained by the atmospheric pressure heating reaction method than by baking. Examples of the atmospheric pressure heating reaction method include: a method A in which a reaction between a barium compound and a hydrolysate of a titanium compound is caused in a strong alkaline aqueous solution; a method B in which a wet reaction between a barium compound and a hydrolysate of a titanium compound is caused in presence of hydrogen peroxide; a method C in which a barium compound in a solution state and a titanium compound in a solution state or a slurry state are mixed while being heated; and a method D in which an alkaline aqueous solution is added to a mixture heated at a temperature of at least 50° C. wherein the mixture is obtained by mixing a barium source and a mineral acid peptizer of a hydrolysate of a titanium compound.

### Coat Layer Formation Process

An example of a method for covering the bases with the coat layers is a method described below. First, the bases are dispersed in a water-based solvent (e.g., water). Next, an aqueous acid solution (e.g., hydrochloric acid) and an alkaline aqueous solution obtained by dissolving an alkali metal salt (e.g., sodium tin oxide) of tin acid and an alkali metal salt of antimonous acid (e.g., sodium antimonous acid) in water are added to a suspension containing the bases. This forms temporary coat layers on the surfaces of the bases. Thereafter, the bases with the temporary coat layers formed thereon are baked (e.g., at a heating temperature of at least 600° C. and no greater than 800° C. for a heating time of at least 0.5 hours and no greater than 4 hours), thereby obtaining the bases covered with the coat layers containing antimony tin oxide. In adding the aqueous acid solution and the alkaline aqueous solution, the pH and the temperature of the suspension are preferably kept within respective specific ranges (e.g., a pH range of at least 9 and no greater than 12 and a temperature range of at least 60° C. and no greater than 80° C.).

In coat layer formation, the amount of addition (in terms of an effective component) of a covering material relative to 100 parts by mass of the bases is preferably at least 40.0 parts by mass and no greater than 150.0 parts by mass, and more preferably at least 60.0 parts by mass and no greater than 90.0 parts by mass. As a result of the amount of the covering materials being set to at least 40.0 parts by mass and no greater than 150.0 parts by mass, the ratio Sn/Ba can be easily adjusted within the aforementioned range.

### Surface Treatment Process

Examples of a method for surface treating the coat layers include a first method and a second method. The first method is a method in which a surface treatment agent is dripped into or sprayed toward a solution containing particles (particles each including a base and a coat layer) before being surface treated while the solution is stirred and heating is performed thereon then. The second method is a method in which particles before being surface treated are added to a solution of a surface treatment agent under stirring and heating is performed thereon then. Examples of heating conditions in the first method and the second method include a heating temperature of at least 40° C. and no greater than 70° C. and a heating time of at least 1 hour and no greater than 60 hours.

The amount of use (in terms of an effective component) of the surface treatment agent in surface treatment is preferably at least 0.5 parts by mass and no greater than 20.0 parts by mass relative to 100 parts by mass of the particles before being surface treated, and more preferably at least 3.0 parts by mass and no greater than 10.0 parts by mass.

### Silica Particles

The silica particles are preferably silica particles subjected to surface treatment for imparting positive chargeability. The silica particles have a number average primary particle diameter of preferably at least 20 nm and no greater than 300 nm, more preferably at least 20 nm and no greater than 100 nm, and further preferably at least 20 nm and no greater than 40 nm. As a result of the number average primary particle diameter of the silica particles being set to at least 20 nm, the silica particles can be inhibited from being buried in the toner mother particles. As a result of the number average primary particle diameter of the silica particles being set to no greater than 300 nm by contrast, the silica particles can be inhibited from being detached from the toner mother particles.

From the viewpoint of satisfactorily performing the function as the silica particles while inhibiting the silica particles from being detached from the toner mother particles, the content ratio of the silica particles in the toner particles is preferably at least 0.1 parts by mass and no greater than 15.0 parts by mass relative to 100 parts by mass of the toner mother particles, and more preferably at least 0.5 parts by mass and no greater than 3.0 parts by mass.

### Additional External Additive Particles

The external additive may further include additional external additive particles other than the specific external additive particles and the silica particles. Examples of the additional external additive particles include particles of metal oxides (specific examples include alumina, magnesium oxide, and zinc oxide), particles of organic acid compounds such as fatty acid metal salts (specific examples include zinc stearate), and resin particles.

### Toner Mother Particles

The toner mother particles contain a binder resin as a main component, for example. The toner mother particles may further contain an internal additive (e.g., at least one of a colorant, a releasing agent, a charge control agent, and a magnetic powder) as necessary. Examples of a toner mother particle production method include a pulverization method and an aggregation method, and the pulverization method is preferable.

### Binder Resin

From the viewpoint of providing a toner excellent in low-temperature fixability, the toner mother particles preferably contain a thermoplastic resin as the binder resin and more preferably contain a thermoplastic resin at a percentage content of at least 85% by mass relative to the total of the binder resin. Examples of the thermoplastic resin include styrene resins, acrylic acid ester resins, olefin resins (e.g., polyethylene resin and polypropylene resin), vinyl resins (e.g., vinyl chloride resin, polyvinyl alcohol, vinyl ether resin, and N-vinyl resin), polyester resins, polyamide resins, and urethane resins. Alternatively, a copolymer of any of these resins, that is, a copolymer (e.g., styrene-acrylic acid ester resin or styrene-butadiene-based resin) with any repeating unit introduced into any of the above resins can be used as the binder resin.

The percentage content of the binder resin in the toner mother particles is preferably at least 60% by mass and no greater than 95% by mass, and more preferably at least 75% by mass and no greater than 90% by mass.

From the viewpoint of increasing low-temperature fixability of the toner of the present disclosure, the binder resin is preferably a polyester resin. The polyester resin is obtained by condensation polymerization of at least one polyhydric alcohol and at least one polybasic carboxylic acid. Examples of the polyhydric alcohol for synthesizing the polyester resin include dihydric alcohols (e.g., diol compounds and bisphenol compounds) and tri- or higher hydric alcohol. Examples of the polybasic carboxylic acid for synthesizing the polyester resin include dibasic carboxylic acids and tri- or higher basic carboxylic acids. Note that a polybasic carboxylic acid derivative (e.g., an anhydride of polybasic carboxylic acid or a polybasic carboxylic acid halide) that can form an ester bond through condensation polymerization may be used instead of the polybasic carboxylic acid.

Examples of the diol compounds include ethylene glycol, diethylene glycol, triethylene glycol, 1,2-propanediol, 1,3-propanediol, 1,4-butanediol, neopentyl glycol, 2-butene-1,4-diol, 1,5-pentanediol, 2-pentene-1,5-diol, 1,6-hexanediol, 1,4-cyclohexanedimethanol, dipropylene glycol, 1,4-benzenediol, polyethylene glycol, polypropylene glycol, and polytetramethylene glycol.

Examples of the bisphenol compounds include bisphenol A, hydrogenated bisphenol A, bisphenol A ethylene oxide adducts (e.g., polyoxyethylene(2,2)-2,2-bis(4-hydroxyphenyl)propane), and bisphenol A propylene oxide adducts.

Examples of the tri- or higher hydric alcohols include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Examples of the dibasic carboxylic acids include maleic acid, fumaric acid, citraconic acid, itaconic acid, glutaconic acid, phthalic acid, isophthalic acid, terephthalic acid, cyclohexanedicarboxylic acid, adipic acid, sebacic acid, azelaic acid, malonic acid, succinic acid, alkyl succinic acids (specific examples include n-butylsuccinic acid, isobutylsuccinic acid, n-octylsuccinic acid, n-dodecylsuccinic acid, and isododecylsuccinic acid), and alkenyl succinic acids (specific examples include n-butenylsuccinic acid, isobutenylsuccinic acid, n-octenylsuccinic acid, n-dodecenylsuccinic acid, and isododecenylsuccinic acid).

Examples of the tri- or higher basic carboxylic acids include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxylpropane, 1,2,4-cyclohexanetricarboxylic acid, tetra(methylenecarboxyl)methane, 1,2,7,8-octanetetracarboxylic acid, pyromellitic acid, and EMPOL trimer acid.

The polyester resin is preferably a condensation polymer of terephthalic acid, isophthalic acid, bisphenol A ethylene oxide adduct, ethylene glycol, and trimellitic acid.

### Colorant

The toner mother particles may contain a colorant. The colorant can be a known pigment or dye that matches the color of the toner of the present disclosure. From the viewpoint of forming high-quality images with the toner of the present disclosure, the content ratio of the colorant is preferably at least 1 part by mass and no greater than 20 parts by mass relative to 100 parts by mass of the binder resin.

The toner mother particles may contain a black colorant. Carbon black can for example be used as a black colorant. Alternatively, a colorant can be used that has been adjusted to a black color using colorants such as a yellow colorant, a magenta colorant, and a cyan colorant.

The toner mother particles may contain a non-black colorant. Examples of the non-black colorant include a yellow colorant, a magenta colorant, and a cyan colorant.

### Releasing Agent

The toner mother particles may contain a releasing agent. The releasing agent is used for the purpose of imparting offset resistance to the toner of the present disclosure, for example. From the viewpoint of imparting sufficient offset resistance to the toner of the present disclosure, the content ratio of the releasing agent is preferably at least 1 part by mass and no greater than 20 parts by mass relative to 100 parts by mass of the binder resin.

Examples of the releasing agent include aliphatic hydrocarbon-based waxes, oxides of aliphatic hydrocarbon-based waxes, plant waxes, animal waxes, mineral waxes, ester waxes of which main component is a fatty acid ester, and waxes in which a part or all of a fatty acid ester has been deoxidized. Examples of the aliphatic hydrocarbon-based waxes include low molecular weight polyethylene, low molecular weight polypropylene, polyolefin copolymers, polyolefin wax, microcrystalline wax, paraffin wax, and Fischer-Tropsch wax. Examples of the oxides of aliphatic hydrocarbon-based waxes include polyethylene oxide wax and block copolymers of polyethylene oxide wax. Examples of the plant waxes include candelilla wax, carnauba wax, Japan wax, jojoba wax, and rice wax. Examples of the animal waxes include beeswax, lanolin, and spermaceti. Examples of the mineral waxes include ozokerite, ceresin, and petrolatum. Examples of the ester waxes of which main component is a fatty acid ester include montanic acid ester wax and castor wax. Examples of the waxes in which a part or all of a fatty acid ester has been deoxidized include deoxidized carnauba wax. Preferably, the releasing agent is paraffin wax.

In a case in which the toner mother particles contain a releasing agent, a compatibilizer may be added to the toner mother particles in order to improve compatibility between the binder resin and the releasing agent.

### Charge Control Agent

The toner mother particles may contain a charge control agent. The charge control agent is used for the purpose of providing a toner with excellent charge stability or an excellent charge rise characteristic, for example. The charge rise characteristic of a toner is an indicator as to whether or not the toner can be charged to a specific charge level in a short period of time. The cationic strength of the toner mother particles can be increased through the toner mother particles containing a positively chargeable charge control agent.

### Toner Production Method

The toner of the present disclosure can be produced by a production method including a toner mother particle preparation process and an external additive addition process.

### Toner Mother Particle Preparation Process

In the toner mother particle preparation process, the toner mother particles are prepared by an aggregation method or a pulverization method, for example.

The aggregation method includes an aggregation process and a coalescence process. The aggregation process involves causing fine particles containing components constituting the toner mother particles to aggregate in an aqueous medium to form aggregated particles. The coalescence process involves causing components contained in the aggregated particles to coalesce in the aqueous medium to form the toner mother particles.

The pulverization method will be described next. The pulverization method can relatively easily achieve preparation of the toner mother particles and can reduce production cost. In a case in which the toner mother particle are prepared by the pulverization method, toner mother particle preparation process includes a melt-kneading process and a pulverization process, for example. The toner mother particle preparation process may further include a mixing process before the melt-kneading process. Furthermore, the toner mother particle preparation process may further include at least one of a fine pulverization process and a classification process after the pulverization process.

In the mixing process, the binder resin and the internal additive added as necessary are mixed to yield a mixture. In the melt-kneading process, a toner material is melted and kneaded to yield a melt-kneaded product. The mixture obtained in the mixing process is used as the toner material, for example. In the pulverization process, the resultant melt-kneaded product is cooled to for example room temperature (25° C.) and pulverized to yield a pulverized product. In a case in which it is necessary to reduce the diameter of the pulverized product obtained in the pulverization process, a process (the fine pulverization process) of further pulverizing the pulverized product may be performed. In order to average the particle diameter of the pulverized product, the resultant pulverized product may be classified (the classification process). Through the above processes, the toner mother particles that correspond to the pulverized product are obtained.

### External Additive Addition Process

In the external additive addition process, the external additive containing the specific external additive particles and the silica particles is attached to the surfaces of the toner mother particles to obtain the toner particles. No particular limitations are placed on a method for attaching the external additive to the surfaces of the toner mother particles, and an example of the method is a method in which the toner mother particles and the external additive are stirred using for example a mixer.

### EXAMPLES

The following provides more specific description of the present disclosure through use of examples. However, the present disclosure is not limited to the scope of the examples.

### Polyester Resin Synthesis

A four-necked flask (reaction vessel) was charged with 1500 g of terephthalic acid, 1500 g of isophthalic acid, 1200 g of bisphenol A ethylene oxide adduct (average number of moles added of ethylene oxide: 2 mol), and 800 g of ethylene glycol. The reaction vessel was heated in a nitrogen atmosphere under stirring of the contents of the reaction vessel until the temperature of the contents reached 250° C. Next, the contents of the reaction vessel were allowed to react at a temperature of 250° C. under the standard pressure for 4 hours. Next, 0.8 g of antimony trioxide, 0.5 g of triphenyl phosphate, and 0.1 g of tetrabutyl titanate were added into the reaction vessel. Next, the internal pressure of the reaction vessel was reduced until the internal pressure of the reaction vessel reached 40 Pa. Then, the reaction vessel was heated until the temperature of the contents of the reaction vessel reached 280° C. Next, the contents of the reaction vessel were allowed to react at a temperature of 280° C. and an internal pressure of 40 Pa for 6 hours. Next, 10.0 g of trimellitic acid as a cross-linking agent was further added into the reaction vessel. Next, the internal pressure of the reaction vessel was returned to the standard pressure, and the reaction vessel was cooled until the temperature of the contents of the reaction vessel reached 230° C. Next, the contents of the reaction vessel were allowed to react at the standard pressure and a temperature of 230° C. for 1 hour. Next, a reaction product (polyester resin) was taken out of the reaction vessel, washed, and dried. In the manner described above, a polyester resin (glass transition point: 45.1° C., softening point: 86.2° C.) was obtained.

### External Additive Particles (TA-1)

A solution containing metatitanic acid was obtained through desulfurization by adding 1N sodium hydroxide aqueous solution to titanyl sulfate so that the resultant solution had a pH of 9.0. Next, 1N hydrochloric acid was added to the solution containing metatitanic acid after desulfurization to adjust (neutralization) the pH of the resultant solution to 5.8. Then, filtration and washing with water were carried out to obtain a wet cake of washed metatitanic acid. Water was added to the washed metatitanic acid to prepare a slurry at a concentration of 2.13 mol/L in terms of TiO₂. To the resultant slurry, 1N hydrochloric acid was added for adjustment of the pH of the slurry to 1.4 (peptization). The peptized metatitanic acid was added into the reaction vessel. The amount of charge of the peptized metatitanic acid was set to an amount corresponding to 1.877 mol in terms of TiO₂.

As the first solution, 2.159 mol (1.15 mol of barium atom relative to 1 mol of titanium atom) of barium chloride was added into the reaction vessel. Next, water is added into the reaction vessel to dilute the contents of the reaction vessel. The amount of water added was set to an amount at which the concentration of the contents after the addition reached 0.939 mol/L in terms of TiO₂. Next, the contents of the reaction vessel were heated to 90° C. under stirring. Then, 553 mL of a sodium hydroxide aqueous solution at a concentration of 10 mol/L was added into the reaction vessel over 1 hour. Next, the contents of the reaction vessel were stirred (stirring speed X: 600 rpm) at a temperature of 95° C. for 1 hour to cause a reaction. A slurry as a result of the reaction was cooled to 50° C. (cooling rate Y; −5° C./min.). Next, 1N hydrochloric acid was added to the contents of the reaction vessel (addition rate Z: 0.5 mL/min.) so that the contents had a pH of 5.0, and the resultant contents were stirred for 1 hour. Thereafter, the resultant slurry was left to stand to precipitate a solid content. The precipitate of which upper layer has been removed by decantation was washed with distilled water, filtered, and dried in the air at 120° C. for 10 hours. Through the above, barium titanate particles were obtained. Observation using an electron microscope revealed that the barium titanate particles were substantially cubic particles. The analytical peak of barium titanate of the barium titanate particles was confirmed by powder X-ray analysis.

Dispersion of 100 g of the resultant barium titanate particles (also referred to below as bases (BT-1)) in pure water resulted in preparation of 2 L of a suspension containing the bases (BT-1) at a concentration of 50 g/L. Next, the resultant suspension was heated to 70° C. Separately, 70.8 g of sodium tin oxide (Na₂SnO₃.3H₂O) and 5.8 g of sodium antimonous acid (NaSbO₂) were dissolved in 500 mL of pure water to prepare an alkaline aqueous solution. In the following, a set of the sodium tin oxide and the sodium antimonous acid may be referred to as “covering material”.

Next, 2N hydrochloric acid and the total amount of the alkaline aqueous solution (amount (part by mass P) of the covering material relative to 100 parts by mass of the bases (BT-1): 76.6 parts by mass) were simultaneously dripped (parallel dripping) into the suspension kept at 70° C. In the dripping, the dripping rate of the 2N hydrochloric acid was adjusted to keep the pH of the suspension in a range of between 10 and 11. After the dripping ended, 2N hydrochloric acid was added to the suspension to adjust the pH of the suspension to between 2 and 3 and the suspension was left to stand for 1 hour for maturation. Next, the suspension was filtered and the resultant residue was washed with pure water and re-filtered. Next, the washed residue was dried at 110° C. for 8 hours and subjected to heating at 650° C. for 1 hour. Through the above, particles (A-1) including the bases (BT-1) containing barium titanate and coat layers covering the bases (BT-1) were obtained. The coat layers contained antimony tin oxide.

Pure water was added to the particles (A-1) to yield a slurry. The resultant slurry was heated to 50° C. and kept at 50° C. Then, IN hydrochloric acid was added thereto to adjust the pH thereof to 2.5. Next, isobutyltrimethoxysilane as a silane coupling agent was added to the slurry and the resultant slurry was stirred for 20 hours. The amount of the silane coupling agent added was 5.0 parts by mass relative to 100 parts by mass of the particles (A-1). Next, a sodium hydroxide solution was added to the slurry to adjust the pH thereof to 6.5 and the resultant slurry was stirred for 1 hour. Next, the slurry was filtered, washed with pure water, and re-filtered. Through the above, a wet cake of particles (specifically, external additive particles (TA-1)) was obtained. The obtained wet cake of the particles was dried in the air at 120° C. for 10 hours. In the manner described above, the external additive particles (TA-1) were obtained. The external additive particles (TA-1) each included the base (BT-1) containing barium titanate, a coat layers covering the base ((BT-1), and a surface treated layer covering the coat layer. The coat layers contained antimony tin oxide. The surface treated layers contained a component derived from the silane coupling agent. The external additive particles (TA-1) had a number average primary particle diameter of 32 nm.

External additive particles (TA-2), (TA-3), and (TB-1) to (TB-7) were prepared according to the same method as that for preparing the external additive particles (TA-1) in all aspects except the following changes.

### External Additive Particles (TA-2)

In preparation of the external additive particles (TA-2), the stirring speed X, the cooling rate Y, and the addition rate Z were appropriately changed to adjust the number average primary particle diameter of the external additive particles (TA-2) to 98 nm.

### External Additive Particles (TA-3)

In preparation of the external additive particles (TA-3), the stirring speed X, the cooling rate Y, and the addition rate Z were appropriately changed to adjust the number average primary particle diameter of the external additive particles (TA-3) to 274 nm.

### External Additive Particles (TB-1)

In preparation of the external additive particles (TB-1), titanium oxide particles (custom-made article produced by Titan Kogyo, Ltd., number average primary particle diameter 32 nm) were used as bases instead of the barium titanate particles (bases (BT-1)). The obtained external additive particles (TB-1) had a number average primary particle diameter of 39 nm.

### External Additive Particles (TB-2)

In preparation of the external additive particles (TB-2), strontium titanate particles (custom-made article produced by Titan Kogyo, Ltd., number average primary particle diameter 28 nm) were used as bases instead of the barium titanate particles (bases (BT-1)). The obtained external additive particles (TB-2) had a number average primary particle diameter of 36 nm.

### External Additive Particles (TB-3)

In preparation of the external additive particles (TB-3), the stirring speed X, the cooling rate Y, and the addition rate Z were appropriately changed to adjust the number average primary particle diameter of the external additive particles (TB-3) to 29 nm. In preparation of the external additive particles (TB-3), the amount (part by mass P) of the covering material relative to 100 parts by mass of the bases (BT-1) was also changed to 38.3 parts by mass.

### External Additive Particles (TB-4)

In preparation of the external additive particles (TB-4), the stirring speed X, the cooling rate Y, and the addition rate Z were appropriately changed to adjust the number average primary particle diameter of the external additive particles (TB-4) to 351 nm.

### External Additive Particles (TB-5)

In preparation of the external additive particles (TB-5), the number of moles of each component was changed as shown below in Table 1 in base preparation to obtain barium titanate particles (also referred to below as bases (BT-2)). Furthermore, the bases (BT-2) were used as bases instead of the bases (BT-1) in preparation of the external additive particles (TB-5). The obtained external additive particles (TB-5) had a number average primary particle diameter of 31 nm.

### External Additive Particles (TB-6)

In preparation of the external additive particles (TB-6), the number of moles of each component was changed as shown below in Table 1 in base preparation to obtain barium titanate particles (also referred to below as bases (BT-3)). Furthermore, the bases (BT-3) were used as bases instead of the bases (BT-1) in preparation of the external additive particles (TB-6). The obtained external additive particles (TB-6) had a number average primary particle diameter of 33 nm.

### External Additive Particles (TB-7)

In preparation of the external additive particles (TB-7), the stirring speed X, the cooling rate Y, and the addition rate Z were appropriately changed to adjust the number average primary particle diameter of the external additive particles (TB-7) to 30 nm. In preparation of the external additive particles (TB-7), the amount (part by mass P) of the covering material relative to 100 parts by mass of the bases (BT-1) was also changed to 114.9 parts by mass.

Note that the particle diameter distribution of the number average primary particle diameter of external additive particles reduces in width as the stirring speed X is increased. As the cooling rate Y is increased, the particle diameter of resultant external additive particles reduces. As the addition rate Z of hydrochloric acid is increased, the particle diameter of the resultant external additive particles increases.

Table 2 below shows the details of the external additive particles (TA-1) to (TA-3) and (TB-1) to (TB-7). The following explains abbreviation of each term used below in Table 2. Note that the external additive particles (TA-1) to (TA-3) and (TB-3) to (TB-7) were the specific external additive particles.

BT: Barium titanate

TiO₂: Titanium oxide

ST: Strontium titanate

ATO: Antimony tin oxide

Particle diameter: Number average primary particle diameter

TABLE 1

| Base | | BT-1 | BT-2 | BT-3 |
|---|---|---|---|---|
| Metatitanic acid [mol] | | 1.877 | 1.877 | 1.877 |
| Barium | [mol] | 2.159 | 1.502 | 2.633 |
| chloride | Equivalent (to metatitanic acid) | 1.15 | 0.80 | 1.40 |

TABLE 2

| | | External additive particle | | | | | | | | | |
|---|---|---|---|---|---|---|---|---|---|---|---|
| | | TA-1 | TA-2 | TA-3 | TB-1 | TB-2 | TB-3 | TB-4 | TB-5 | TB-6 | TB-7 |
| Base | | BT-1 | BT-1 | BT-1 | TiO₂ | ST | BT-1 | BT-1 | BT-2 | BT-3 | BT-1 |
| Covering | Type | ATO | ATO | ATO | ATO | ATO | ATO | ATO | ATO | ATO | ATO |
| layer | Part by mass P | 76.6 | 76.6 | 76.6 | 76.6 | 76.6 | 38.3 | 76.6 | 76.6 | 76.6 | 114.9 |

| | | | | | | | | | | |
|---|---|---|---|---|---|---|---|---|---|---|
| Particle diameter [nm] | 32 | 98 | 274 | 39 | 36 | 29 | 351 | 31 | 33 | 30 |

### Toner Production

Toners of Examples 1 to 6 and Comparative Examples 1 to 11 were produced according to the following methods.

### Example 1

Using an FM mixer (“FM-20B”, product of Nippon Coke & Engineering Co., Ltd.), 90 parts by mass of the aforementioned polyester resin, 5 parts by mass of a carbon black (“MA100”, product of Mitsui Chemicals, Inc.), and 5 parts by mass of a paraffin wax (“HNP-9”, product of Nippon Seiro Co., Ltd.) were mixed at a rotational speed of 2400 rpm/min. for 180 seconds. The resultant mixture was melt-kneaded using a twin screw extruder (“PCM-30”, product of SHIBAURA MACHINE CO., LTD.) under conditions of a material feeding speed of 5 kg/hour, a shaft rotational speed of 150 rpm, and a setting temperature (cylinder temperature) of 150° C. The resultant melt-kneaded product was cooled. The cooled melt-kneaded product was coarsely pulverized using a pulverizer (“ROTOPLEX (registered Japanese trademark) Model 16/8”, product of Hosokawa Micron Corporation). The resultant coarsely pulverized product was finely pulverized using an ultrasonic jet pulverizer (“ULTRASONIC JET MILL Model I”, product of Nippon Pneumatic Mfg. Co., Ltd.). The resulting finely pulverized product was classified using a classifier (“ELBOW JET Model EJ-LABO”, product of Nittetsu Mining Co., Ltd.). As a result, toner mother particles with a volume median diameter (D₅₀) of 6.7 μm were obtained.

### External Addition

Using an FM mixer (“FM-10B”, product of Nippon Coke & Engineering Co., Ltd.), 100 parts by mass of the toner mother particles, 1.6 parts by mass of silica particles (“AEROSIL (registered Japanese trademark) REA90”, product of NIPPON AEROSIL CO., LTD., silica particles with positive chargeability imparted through use of a surface treatment agent, number average primary particle diameter 20 nm), and 0.8 parts by mass of the external additive particles (TA-1) were mixed at a rotational speed of 3500 rpm for 5 minutes. The resultant mixture was sifted using a 200-mesh sieve (opening: 75 μm). Through the above, a toner of Example 1 was obtained that included toner particles including toner mother particles and an external additive (the external additive particles (TA-1) and the silica particles) attached to the surfaces of the toner mother particles.

Note that the silica particles were surface treated with antimony tin oxide. As such, the silica particles contained a trace amount of tin as a metal element in addition to silicon.

### Examples 2 to 6 and Comparative Examples 1 to 11

Toners of Examples 2 to 6 and Comparative Examples 1 to 11 were produced according to the same method as that for producing the toner of Example 1 in all aspects other than that the types and amounts of addition of the external additive particles (specifically, the external additive particles (TA-1) to (TA-3) and (TB-1) to (TB-7)) and the amount of the silica particles added were changed to those shown below in Tables 3 to 5. Note that the term “Part by mass” below in Tables 3 to 5 indicates an amount in terms of part by mass relative to 100 parts by mass of the toner mother particles.

### Fluorescent X-ray Analysis

With respect to each of the toners of Examples 1 to 6 and Comparative Examples 1 to 11, each ratio of metal elements (silicon, titanium, barium, and tin) contained in the toner particles was measured by fluorescent X-ray analysis

Specifically, a columnar pellet with a diameter of 20 mm was formed by press forming 0.5 g of a measurement target (any of the toners of Examples 1 to 6 and

Comparative Examples 1 to 11) using a tablet forming briquetting presser (“BRE-33”, product of MAEKAWA TESTING MACHINE MFG. Co., Ltd.). Fluorescent X-ray analysis was performed on the resultant pellet under the following conditions to plot a fluorescent X-ray spectrum (horizontal axis: energy, vertical axis: intensity (number of photons) having peaks derived from silicon, titanium, barium, and tin. The X-ray intensity of each peak derived from the measured elements on the plotted fluorescent X-ray spectrum was converted to a percentage content (unit: % by mass) using a pre-plotted calibration curve. The mass ratios Ba/Ti, Ba/Si, and Sn/Ba in the measurement target were calculated based on the converted percentage contents. The results are shown below in Tables 3 to 5.

### Conditions of Fluorescent X-ray Analysis

Analyzer: Scanning fluorescent X-ray analyzer (“ZSX”, product of Rigaku Corporation)

X-ray tube (X-ray source): Rh (rhodium)

Excitation conditions: Tube voltage of 50 kV and tube current of 50 mA

Measurement range (X-ray irradiation range): Diameter of 30 mm

Measured element: Silicon, titanium, barium, and tin

### Evaluation

With respect to each of the toners of Examples 1 to 6 and Comparative Examples 1 to 11, occurrence or non-occurrence of fogging and occurrence or non-occurrence of image flow were evaluated according to the following methods. The evaluation results are shown below in Tables 3 to 5.

### Preparation of Evaluation Developer

Using a ball mill, 100 parts by mass of a carrier (carrier for TASKalfa (registered Japanese trademark) 5550ci, product of KYOCERA Document Solutions Inc.) and 10 parts by mass of the toner (specifically, any of the toners of Examples 1 to 6 and Comparative Examples 1 to 11) were mixed for 30 minutes. In the manner described above, an evaluation developer was obtained.

### Evaluation Apparatus

The evaluation developer was charged into an accommodation section of a development device for black color of a multifunction peripheral (“TASKalfa (registered Japanese trademark) 5550ci”, product of KYOCERA Document Solutions Inc.). Furthermore, the toner (specifically, the same toner as the toner contained in the evaluation developer) was charged into a toner container for black color of the multifunction peripheral. The multifunction peripheral prepared as above was used as an evaluation apparatus. “COLORCOPY (registered Japanese trademark) produced by Mondi plc was used as plain paper (A4 size) for evaluation.

### Fogging

Occurrence or non-occurrence of fogging was determined under each of the following three conditions A to C. If evaluation of fogging was acceptable in any of the conditions A to C, the evaluation developer was determined to be capable of inhibiting occurrence of fogging (evaluation: A). If evaluation of fogging was failing in at least one of the conditions A to C by contrast, the evaluation developer was determined to be incapable of inhibiting occurrence of fogging (evaluation: B)

### Condition A

An image (printing rate: 5%) was consecutively printed on 4000 sheets of the plain paper using the evaluation apparatus in an environment at a temperature of 10° C. and a relative humidity of 10%. Next, an evaluation image (printing rate: 20%) was consecutively printed on 500 sheets of the plain paper using the evaluation apparatus in an environment at a temperature of 10° C. and a relative humidity of 10%. In the manner described above, 500 evaluation image sheets were obtained. The evaluation image sheets each included a solid image portion and a blank portion (non-printed area).

The reflection density of the blank portion of each evaluation image sheet was measured using a white light meter (“TC-6DS/A”, product of Tokyo Denshoku Co., Ltd.). Separately, the reflection density of the plain paper that has not been used was measured. The fogging density (FD) of each evaluation image sheet was calculated using the following equation. The fogging density (FD) of each of the resultant 500 evaluation image sheets was obtained in the manner described above. An average of the fogging densities (FD) of the 500 evaluation image sheets was calculated then. The calculated average was taken to be a fogging evaluation value under the condition A.

FD=(reflection density of blank portion)−(reflection density of non-used plain paper)

The following indicates evaluation criteria for fogging evaluation under the condition A.

Acceptable: Evaluation value of no greater than 0.010

Failing: Evaluation value of greater than 0.010

### Condition B

An image (printing rate: 1%) was consecutively printed on 10,000 sheets of the plain paper using the evaluation apparatus in an environment at a temperature of 32.5° C. and a relative humidity of 80%. Next, an evaluation image (printing rate: 20%) was consecutively printed on 500 sheets of the plain paper using the evaluation apparatus in an environment at a temperature of 32.5° C. and a relative humidity of 80%. In the manner described above, 500 evaluation image sheets were obtained. The evaluation image sheets each included a solid image portion and a blank portion (non-printed area).

A fogging evaluation value (average of fogging densities (FD) of 500 evaluation image sheets) under the condition B was calculated according to the same method as that in the fogging evaluation under the condition A.

The following indicates evaluation criteria for fogging evaluation under the condition B.

Acceptable: Evaluation value of no greater than 0.010

Failing: Evaluation value of greater than 0.010

### Condition C

The evaluation apparatus was left to stand in an environment at a temperature of 32.5° C. and a relative humidity of 80%. After the leaving, an evaluation image (printing rate: 20%) was consecutively printed on 10 sheets of the plain paper using the evaluation apparatus in an environment at a temperature of 32.5° C. and a relative humidity of 80%. In the manner described above, 10 evaluation image sheets were obtained. The evaluation image sheets each included a solid image portion and a blank portion (non-printed area). A fogging evaluation value under the condition C was calculated according to the same method as that in the fogging evaluation under the condition A in all aspects other than the following changes. Specifically, the average of the fogging densities (FD) of the 500 evaluation image sheets was taken to be an evaluation value in the fogging evaluation under the condition A. In fogging evaluation under the condition C by contrast, a maximum value of the fogging densities (FD) of the 10 evaluation image sheets was taken to be an evaluation value.

The following indicates evaluation criteria for fogging evaluation under the condition C.

Acceptable: Evaluation value of no greater than 0.010

Failing: Evaluation value of greater than 0.010

### Image Flow

A printing durability test was carried out using the evaluation apparatus in a normal-temperature and normal-humidity environment (a temperature of 23° C. and a relative humidity of 50%). The printing durability test was such that an image pattern (X6931:2005 defined in the Japanese Industrial Standards) including characters was consecutively printed on 5000 sheets of the plain paper. Thereafter, image quality (specifically, degree of degradation of character identification resulting from image flow) of the characters in the image pattern printed on the last (5000^{th}) sheet was evaluated by visual observation (first evaluation).

After the first evaluation, the evaluation apparatus was left to stand for 24 hours in a high-temperature and high-humidity environment (a temperature of 35° C. and a relative humidity of 80%). Next, the image pattern (X6931:2005 defined in the Japanese Industrial Standards) was printed again on the plain paper using the evaluation apparatus. Thereafter, image quality (specifically, degree of degradation of character identification resulting from image flow) of the characters in the printed image pattern was evaluated by visual observation (second evaluation).

Occurrence or non-occurrence of image flow was evaluated according to the following criteria.

A (acceptable): There are no parts where character identification was difficult in both the first evaluation and the second evaluation.

B (failing): There is a part where character identification was difficult due to image flow in the second evaluation.

TABLE 3

| | | Example | | | | | |
|---|---|---|---|---|---|---|---|
| | | 1 | 2 | 3 | 4 | 5 | 6 |
| External | Type | TA-1 | TA-1 | TA-1 | TA-1 | TA-2 | TA-3 |
| additive | Part by mass | 0.8 | 0.4 | 1.2 | 1.6 | 1.6 | 2.4 |
| particles | | | | | | | |
| Silica | Part by mass | 1.6 | 1.6 | 1.6 | 2.0 | 1.6 | 1.6 |
| particles | | | | | | | |
| Metal | Ba/Ti | 0.37 | 0.37 | 0.37 | 0.37 | 0.37 | 0.37 |
| element | Ba/Si | 0.12 | 0.06 | 0.16 | 0.13 | 0.16 | 0.19 |
| | Sn/Ba | 3.1 | 4.3 | 2.2 | 2.2 | 3.9 | 4.6 |
| Evaluation | Fogging | A | A | A | A | A | A |
| | Image flow | A | A | A | A | A | A |

TABLE 4

| | | Comparative Example | | | | | |
|---|---|---|---|---|---|---|---|
| | | 1 | 2 | 3 | 4 | 5 | 6 |
| External | Type | TB-1 | TB-2 | TB-3 | TB-4 | TA-1 | TA-1 |
| additive | Part by mass | 0.8 | 0.8 | 0.8 | 0.8 | 0.2 | 1.6 |
| particle | | | | | | | |
| Silica | Part by mass | 1.6 | 1.6 | 1.6 | 1.6 | 1.6 | 1.6 |
| particles | | | | | | | |
| Metal | Ba/Ti | 0.00 | 0.00 | 0.42 | 0.37 | 0.37 | 0.37 |
| element | Ba/Si | 0.00 | 0.00 | 0.15 | 0.26 | 0.03 | 0.21 |
| | Sn/Ba | 238 | 311 | 0.13 | 5.9 | 5.7 | 1.9 |
| Evaluation | Fogging | B | A | B | B | B | B |
| | Image flow | A | B | A | A | B | A |

TABLE 5

| | | Comparative Example | | | | |
|---|---|---|---|---|---|---|
| | | 7 | 8 | 9 | 10 | 11 |
| External additive | Type | TA-1 | TB-5 | TB-6 | TA-1 | TB-7 |
| particle | Part by mass | 1.6 | 0.8 | 0.8 | 0.8 | 0.8 |
| Silica particles | Part by mass | — | 0.4 | 2.0 | 2.0 | 1.6 |
| Metal element | Ba/Ti | 0.37 | 0.08 | 0.66 | 0.37 | 0.37 |
| | Ba/Si | 189 | 0.13 | 0.09 | 0.03 | 0.12 |
| | Sn/Ba | 8.9 | 4.2 | 3.3 | 4.8 | 5.3 |
| Evaluation | Fogging | A | A | B | B | A |
| | Image flow | B | B | A | B | B |

The toners of Examples 1 to 6 each were a toner including toner particles. The toner particles each included a toner mother particle and an external additive attached to the surface of the toner mother particle. The external additive contained the specific external additive particles and silica particles. The specific external additive particles each included a base containing barium titanate and a coat layer covering the base. The coat layers contained antimony tin oxide. The mass ratios of the metal elements contained in the toner particles satisfied the aforementioned formulas (1) to (3). As shown in Table 3, the toners of Examples 1 to 6 each inhibited occurrence of fogging and image flow.

By contrast, the external additive particles (TB-1) used in the toner of Comparative Example 1 included bases containing titanium oxide. The external additive particles (TB-1), of which the bases containing titanium oxide had a dielectric constant lower than that of barium titanate, are determined to have not inhibited local charge concentration in the toner particles. As a result, the toner of Comparative Example 1 did not inhibit occurrence of fogging.

The external additive particles (TB-2) used in the toner of Comparative Example 2 included bases containing strontium titanate. The external additive particles (TB-2), of which the bases containing strontium titanate had a Mohs hardness lower than that of barium titanate, are determined to have exhibited insufficient abrasion action. As a result, the toner of Comparative Example 2 did not inhibit occurrence of image flow.

The metal elements contained in the toner particles of the toner of Comparative Example 3 had a mass ratio Sn/Ba of no greater than 1.5. The external additive particles (TB-3) used in the toner of Comparative Example 3 are determined to have had an excessively high volume resistivity. As a result, the toner of Comparative Example 3 did not inhibit occurrence of fogging.

The metal elements contained in the toner particles of the toner of Comparative Example 4 had a mass ratio Ba/Si of at least 0.20 and a mass ratio Sn/Ba of at least 5.0. The toner of Comparative Example 4 was determined to have contained an excessive amount of the external additive particles (TB-4) relative to the amount of the silica particles. Furthermore, the external additive particles (TB-4) used in the toner of Comparative Example 4 are determined to have had an excessively low volume resistivity. As a result, the toner of Comparative Example 4 did not inhibit occurrence of fogging.

The metal elements contained in the toner particles of the toner of Comparative Example 5 had a mass ratio Ba/Si of no greater than 0.05. The toner of Comparative Example 5 is determined to have had an insufficient amount of the external additive particles (TA-1) relative to the amount of the silica particles. As a result, the toner of Comparative Example 5 did not inhibit occurrence of fogging and image flow.

The metal elements contained in the toner particles of the toner of Comparative Example 6 had a mass ratio Ba/Si of at least 0.20. The toner of Comparative Example 6 is determined to have contained an excessive amount of the external additive particles (TA-1) relative to the amount of the silica particles. As a result, the toner of Comparative Example 6 did not inhibit occurrence of fogging.

The external additive of the toner of Comparative Example 7 contained no silica particles. As a result, the toner of Comparative Example 7 insufficiently inhibited image follow.

The metal elements contained in the toner particles of the toner of Comparative Example 8 had a mass ratio Ba/Ti of no greater than 0.10. The external additive particles (TB-5) of the toner of Comparative Example 8 are determined to have exhibited insufficient abrasion action. As a result, the toner of Comparative Example 8 did not inhibit occurrence of image flow.

The metal elements contained in the toner particles of the toner of Comparative Example 9 had a mass ratio Ba/Ti of at least 0.60. The external additive particles (TB-6) of the toner of Comparative Example 9 are determined to have had a low dielectric constant or a high volume resistivity. As a result, the toner of Comparative Example 9 did not inhibit occurrence of fogging.

The metal elements contained in the toner particles of the toner of Comparative Example 10 had a mass ratio Ba/Si of no greater than 0.05. The amount of the external additive particles (TA-1) relative to the amount of the silica particles was determined to have been insufficient in the toner of Comparative Example 10. As a result, the toner of Comparative Example 10 did not inhibit occurrence of fogging and image flow.

The metal elements contained in the toner particles of the toner of Comparative Example 11 had a mass ratio Sn/Ba of at least 5.0. The external additive particles (TB-7) used in the toner of Comparative Example 11 are determined to have had an excessively low volume resistivity. As a result, the toner of Comparative Example 11 did not inhibit occurrence of fogging.

What is claimed is:

1. A toner comprising toner particles, wherein
the toner particles each include a toner mother particle and an external additive attached to a surface of the toner mother particle,
the external additive contains specific external additive particles and silica particles,
the specific external additive particles each include a base containing barium titanate and a coat layer covering the base,
the coat layer contains antimony tin oxide, and
mass ratios of metal elements contained in the toner particles satisfy formulas (1) to (3):
0.10<(Ba/Ti)<0.60 (1)
0.05<(Ba/Si)<0.20 (2)
1.5<(Sn/Ba)<5.0 (3).

2. The toner according to claim 1, wherein the specific external additive particles have a content ratio of at least 0.3 parts by mass and no greater than 5.0 parts by mass relative to 100 parts by mass of the toner mother particles.

3. The toner according to claim 1, wherein
the specific external additive particles have a number average primary particle diameter of at least 20 nm and no greater than 300 nm.

4. The toner according to claim 1, wherein
the specific external additive particles each further include a surface treated layer covering the coat layer, and
the surface treated layer contains a component derived from a silane coupling agent.
